(19) United States
(12) Patent Application Publication
(10) Pub. No.: US 2015/0114969 A1
(43) Pub. Date: Apr. 30, 2015

(54) BAG STORAGE AND RECYCLING SYSTEM

(71) Applicant: Dale M. Martin, Cambria Heights, NY (US)

(72) Inventor: Dale M. Martin, Cambria Heights, NY (US)

(21) Appl. No.: 14/220,953

(22) Filed: Mar. 20, 2014

Related U.S. Application Data
(60) Provisional application No. 61/897,519, filed on Oct. 30, 2013.

(51) Int. Cl. B65F 1/14; B65D 25/56; B65D 25/20

(52) U.S. Cl. CPC B65F 1/141; B65D 25/20; B65D 25/56
USPC 220/495.08; 220/694; 220/676

(57) ABSTRACT

A bag storage and recycling system includes a basket having a bottom end, a top opening, an interior housing, and an exterior surface. The basket may include a plurality of hooks attached to and extending out from the exterior surface. The basket may include a plurality of holes along the exterior surface. A base may attach to the bottom end of the basket. The base may include a storage compartment enclosed within and accessed through an access mechanism.

### CROSS-REFERENCE TO RELATED APPLICATION

This application claims the benefit of U.S. provisional application No. 61/897,519, filed Oct. 30, 2013, the contents of which are herein incorporated by reference.

### BACKGROUND OF THE INVENTION

The present invention relates to waste baskets and, more particularly, to a bag storage and recycling system.

Currently, there is a problem with what to do with plastic shopping bags. Current devices do not work well because bags tend to fall into the container before they are filled. Current waste baskets do not have built in storage and side hooks. They have no storage capacity to promote recycling of plastic bags.

As can be seen, there is a need for a plastic bag storage and recycling system that provides built in storage and hooks to secure bags.

### SUMMARY OF THE INVENTION

In one aspect of the present invention, a bag storage and recycling system comprises: a basket having a bottom end, a top opening, an interior housing, and an exterior surface; and a base attached to the bottom end of the basket.

In another aspect of the present invention, a bag storage and recycling system comprises: a basket having a bottom end, a top opening, an interior housing, an exterior surface, and a plurality of holes along the exterior surface; a plurality of hooks attached to the exterior surface of the basket; and a base attached to the bottom end of the basket, wherein the base comprises a storage compartment accessed through an access mechanism.

In another aspect of the present invention, a method for storing and recycling plastic bags comprises: placing a plastic bag having loop handles within a bag storage and recycling device, wherein the bag storage and recycling device is defined by a basket having a bottom end, a top opening, an interior housing, and an exterior surface; a plurality of hooks attached to extended out from the exterior surface of the basket; and a base attached to the bottom end of the basket; selecting the appropriate level plurality of hooks for the plastic bag being used; and looping the loop handles of the plastic bag around the plurality of hooks securing the plastic bag in place within the basket.

These and other features, aspects and advantages of the present invention will become better understood with reference to the following drawings, description and claims.

### BRIEF DESCRIPTION OF THE DRAWINGS

FIG. 1 is an exploded front elevation view of an exemplary embodiment of the present invention;

FIG. 2 is a perspective view of an exemplary embodiment of the present invention in use; and

FIG. 3 is a partial cross-sectional view of an exemplary embodiment of the present invention taken on line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bag storage and recycling system that may include a basket having a bottom end, a top opening, an interior housing, and an exterior surface. The basket may include a plurality of hooks attached to and extending out from the exterior surface. The basket may include a plurality of holes along the exterior surface. A base may attach to the bottom end of the basket. The base may include a storage compartment enclosed within and accessed through an access mechanism. The device may secure bags while in use, and may have storage for additional bags.

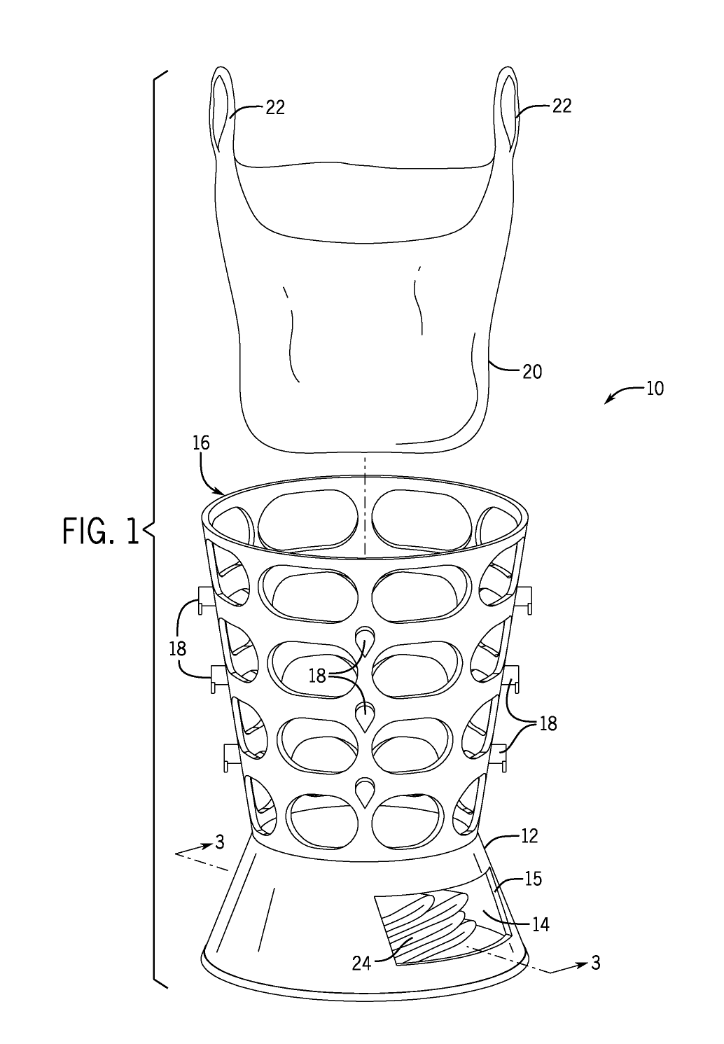

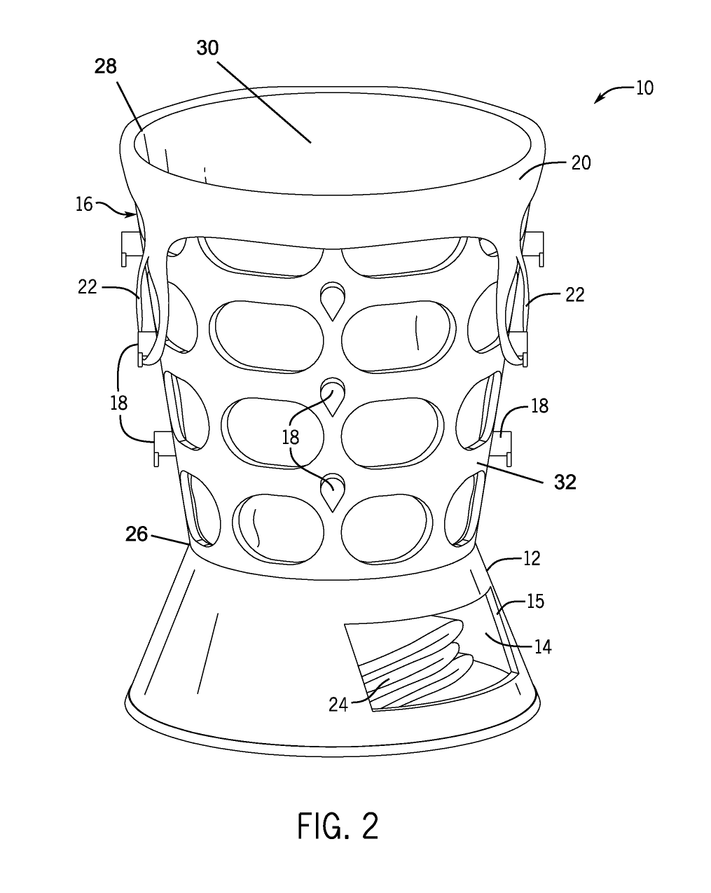

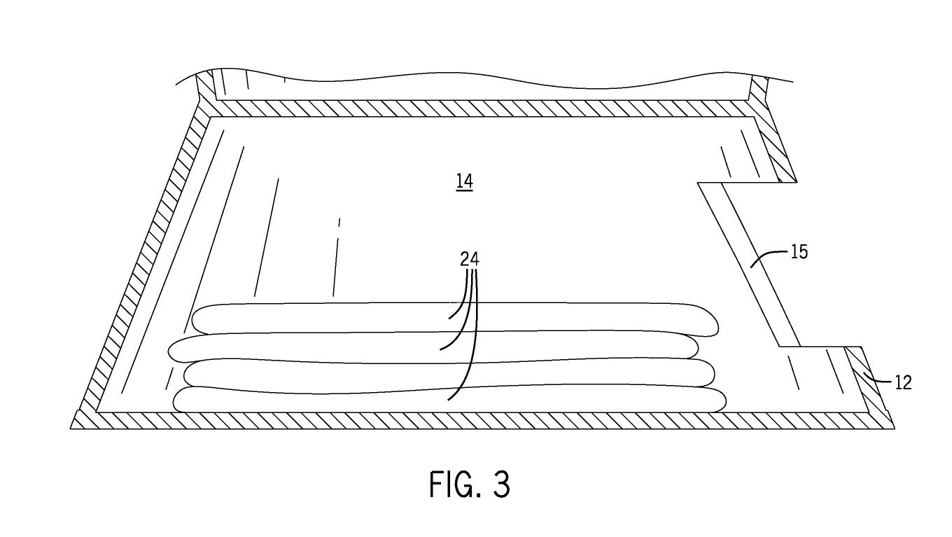

As is illustrated in FIGS. 1 through 3, the bag storage and recycling system may include a storage and recycling device 10. The storage and recycling device 10 may include a basket 16. The basket 16 may have a bottom end 26, a top opening 28, an interior housing 30, and an exterior surface 32. A base 12 may be attached to the bottom end 26 of the basket 16.

In certain embodiments, a plurality of hooks 18 may attach to and extend out from the exterior surface 32 of the basket 16. In certain embodiments, a plurality of holes may be exposed along the exterior surface 32 as well. The plurality of holes may allow for a person to view the level of the content of a plastic bag 20 that may be placed within the storage and recycling device 10.

In certain embodiments, the base 12 may have an approximate conical frustum shape. The base 12 may include a storage compartment 14. The storage compartment 14 may be accessed through an access mechanism 15 such as a permanent opening, a doorway, or the like. Stored plastic bags 24 may be placed within the storage compartment 14 for later use. The storage compartment 14 provides a location for the plastic bags 20 so that the plastic bags 20 may not just be thrown away without being used again. The storage compartment 14 allows for the plastic bags 20 to be recycled for further use such as for placing within the interior housing 30 of the waste basket 16 or the like.

In certain embodiments, the present invention may be made from a 3-D printer, other ways to create molded plastic structures or the like. The material used may be a hard plastic or the like. In certain embodiments, special themes may be printed along the outside of the device 10, such as for boys and girls.

A method of using the present invention may include the following. A person may place the plastic bag 20 into the basket 16. The person may secure the plastic bag 20 by placing a set of loop handles 22 of the plastic bag 20 around the plurality of hooks 18. Various sizes of plastic bags 20 may be used with the current storage and recycling device 10. The plurality of hooks 18 may be positioned at various heights along the exterior surface 32 of the basket 16 so that various lengths of the plastic bag 20 may be used and secured by the device. The plastic bag 20 may be secured from falling further into the interior housing 30 of the basket 16 by the plurality of hooks 18.

It should be understood, of course, that the foregoing relates to exemplary embodiments of the invention and that modifications may be made without departing from the spirit and scope of the invention as set forth in the following claims.

What is claimed is:

1. A bag storage and recycling system comprising:
a basket having a bottom end, a top opening, an interior housing, and an exterior surface; and
a base attached to the bottom end of the basket.

2. The bag storage and recycling system of claim 1, further comprising a storage compartment enclosed within the base.

3. The bag storage and recycling system of claim 2, further comprising an access mechanism to the storage compartment.

4. The bag storage and recycling system of claim 1, wherein the basket comprises a plurality of hooks attached to and extending out from the exterior surface of the basket.

5. The bag storage and recycling system of claim 1, wherein the basket comprises a plurality of holes along the exterior surface of the basket.

6. The bag storage and recycling system of claim 1, wherein the base has an approximately conical frustum shape.

7. A bag storage and recycling system comprising:
a basket having a bottom end, a top opening, an interior housing, an exterior surface, and a plurality of holes along the exterior surface;
a plurality of hooks attached to the exterior surface of the basket; and
a base attached to the bottom end of the basket, wherein the base comprises a storage compartment accessed through an access mechanism.

8. A method for storing and recycling plastic bags comprising:
placing a plastic bag having loop handles within a bag storage and recycling device, wherein the bag storage and recycling device is defined by a basket having a bottom end, a top opening, an interior housing, and an exterior surface; a plurality of hooks attached to extended out from the exterior surface of the basket; and a base attached to the bottom end of the basket;
selecting the appropriate level plurality of hooks for the plastic bag being used; and
looping the loop handles of the plastic bag around the plurality of hooks securing the plastic bag in place within the basket.

9. The method of claim 8, further comprising the step of storing additional plastic bags within a storage compartment within the base of the device.

10. The method of claim 9, further comprising accessing the additional plastic bags through an access mechanism.

11. The method of claim 10, further comprising replacing the plastic bag when full with a plastic bag from the storage compartment.
